(19) United States
(12) Patent Application Publication
(10) Pub. No.: US 2026/0357085 A1
(43) Pub. Date: Nov. 12, 2026

(54) TWO COMPONENT INTUMESCENT COATING SYSTEM

(71) Applicant: SWIMC LLC, Cleveland, OH (US)

(72) Inventors: Jakub WAWRZYCZEK, Bolton (GB); Simon BUTTERFIELD, Bolton (GB)

(21) Appl. No.: 19/148,096

(22) PCT Filed: Jan. 9, 2024
(86) PCT No.: PCT/US2024/010799

§ 371 Date: Jul. 15, 2025

Related U.S. Application Data
(60) Provisional application No. 63/480,232, filed on Jan. 17, 2023.

(51) Int. Cl. C09D 5/18; C09D 4/06; C09D 7/48; C09D 7/61; C09D 7/63; C09D 133/10

(52) U.S. Cl. CPC C09D 5/185; C09D 4/06; C09D 7/48; C09D 7/61; C09D 7/63; C09D 133/10

(57) ABSTRACT

A liquid intumescent coating composition comprising a resin system is described herein. The resin system comprises at least one polymeric component, one or more ethylenically unsaturated monomeric components, an inhibitor, and at least one intumescent ingredient. The coating composition is provided as a two-pack system that can be applied via a single-leg spray process and is curable to a solid state in a free-radical polymerization reaction.

### TECHNICAL FIELD

The present invention relates to liquid intumescent coating compositions that have particular, but not exclusive, application in protecting steel structures in a fire situation, and that can be applied using a single leg spray apparatus or system.

### BACKGROUND OF THE INVENTION

Intumescent coating compositions are commonly used to protect structural steel components in buildings against the effects of cellulosic fire conditions. They contain a resin system “pigmented” with various intumescent ingredients that under the influence of heat, react together to produce an insulating foam or “char”, having low thermal conductivity, which has a volume many times that of the original coating. This char greatly reduces the rate of heating experienced by the steel, thus extending the time before the steel loses its integrity and the building collapses, thereby allowing additional time for safe evacuation.

During a fire situation, a steel structure will heat up, the rate of heating depending on the specific dimensions of the steel sections used in the structure. The rate of heating is dependent on the Hp/A value of the section, where Hp is the perimeter of the steel when viewed in cross-section, and A is the cross-sectional area.

A steel section with a large perimeter (Hp) will receive more heat than one with a smaller perimeter. On the other hand, the greater the cross-sectional area (A), the more heat the steel section can absorb. Thus, a large thin steel section having a high Hp/A value will heat up more quickly than a small thick section having a lower Hp/A value.

The thickness of the coating that is applied depends on the Hp/A value of the steel, its configuration, and the level of fire protection required. The latter is typically specified from 30 minutes to 120 minutes, this being the time taken for the steel to reach its critical failure temperature (550 °C) under standard test conditions.

Typically the dry film thickness of intumescent coating applied varies from 250 μm to several millimeters, depending on the level of fire protection required. With solvent based or water based prior art intumescent coatings, the higher dry film thicknesses can only be achieved by the application of multiple coats.

Prior art intumescent coatings designed for cellulosic fire protection tend to be based on high molecular weight thermoplastic resins based on acrylate, methacrylate and/or vinyl chemistry and require a high proportion of organic solvent or water to facilitate application to the substrate to be fire protected. This leads to slow and often protracted drying times, especially when high wet film thicknesses are applied (up to 2 mm per coat), since the rate of drying is dependent on the evaporation of the carrier solvent. Increasingly stringent legislation concerning organic solvent emissions has meant greater use of water based products but slow drying remains a problem, particularly when the relative humidity is high.

Where multiple coats are required the problems of slow drying are exacerbated, particularly with solvent based coatings, where solvent from subsequent coats can strike back into the previous coats.

The use of ovens or near infra-red heaters can reduce the drying times, though these are expensive to operate, and due to the thermoplastic nature of the coatings, cooling is necessary prior to handling in order to prevent damage. Cooling of thick heavy steel sections, can take a relatively long time.

Traditionally, intumescent coatings were applied on-site to steel structures during the construction phase of the building. More recently in-shop application has become more common practice, as better control of application conditions is possible. Slow drying means that throughput is compromised, as coated steel sections cannot be moved until they are hard enough to resist damage. This issue is resolved primarily by providing relatively quick-drying intumescent coating formulations of the type described in U.S. Pat. No. 8,784,705, for example.

Conventionally, some multicomponent intumescent coating compositions are applied using plural component spray pumps or systems. In such applications, the reactive components are packaged separately in two packs with an initiator in a third pack. The contents are mixed just prior to application. However, the plural component spray system and three-pack coatings are not suited to on-site application of durable coating compositions, especially those outside the context of water-based applications. Moreover, the cost of applying these coatings with plural component spray systems can be prohibitive, especially consider the three-pack design of the current coating systems.

Accordingly, there remains a need for liquid intumescent coating compositions that can be applied on-site using an efficient and cost-effective spray apparatus and efficient and cost-effective packaging of the coating compositions.

### SUMMARY

According to a first aspect of the present invention there is provided a liquid intumescent coating composition comprising a resin system comprising at least one polymeric component, at least one ethylenically unsaturated monomeric component, an inhibitor component, and at least one intumescent ingredient, the coating composition being curable to a solid state by free radical polymerization, preferably on initiation by organic peroxide.

According to a second aspect of the present invention there is provided a method of curing a liquid intumescent coating composition to a solid state by free radical polymerization comprising the step of adding an initiator, preferably organic peroxide, to the liquid intumescent coating composition, wherein the coating composition comprise at least one polymeric component, at least one ethylenically unsaturated monomeric component and at least one intumescent ingredient.

According to a third aspect of the present invention there is provided a method of applying a two-pack liquid intumescent coating composition including the steps of providing a first pack that includes at least one polymeric component. The polymeric component includes a solid thermoplastic resin and at least one ethylenically unsaturated monomeric component along with an inhibitor component, and an intumescent ingredient. A second pack includes at least a peroxide inhibitor. The first and second parts are mixed to form a mixture. A reaction is initiated to cure the composition to a solid state by free radical polymerization, and the formed mixture may be applied to a substrate by a single-leg process.

It is noted that the liquid intumescent coating composition may comprise one or more solid components.

### DETAILED DESCRIPTION

The present description provides a liquid intumescent coating composition that can be applied by a single-leg process or system. Briefly, the present description provides a quick-drying coating composition in that the initiator initiates the conversion of the intumescent coating composition into a solid state via a free-radical polymerization reaction. In contrast to commercially available three-pack coating compositions intended for plural component spray application systems, however, the present invention provides a two-pack composition where the polymeric (reactive) components are present together in a first pack while the initiator is in a second pack and initiates the conversion of the intumescent coating composition into a solid state via a free-radical polymerization reaction. Pot life concerns from the use of the reactive monomers in a single pack are addressed by the inclusion of an inhibitor along with the polymeric component in the first pack.

The fact that the coating dries by free radical polymerization, as opposed to solvent evaporation also has the added benefit of giving rise to much higher “solids” content of the coating, i.e. typically 90-100% of the applied wet coating becomes dry coating on the substrate, compared to typical prior art coatings where only 60-80% of the applied film thickness remains in the dry film.

The coating has particular, but not exclusive application in the coating of steel structures to provide protection against fire by forming an intumescent and insulating char. The coatings described herein are particularly suitable for on-site application by single-leg spray systems, but may be used for in-shop application as well.

Steel sections and other materials that are coated with such an intumescent coating composition harden much more rapidly than prior art materials, since the drying time is dependent on the relatively rapid free-radical chemical reactions rather than on complete evaporation of volatile components. Drying times are reduced from 24 hours or longer, to around 60 minutes, (or even less with the incorporation of additional accelerator). This provides significant benefits to in-shop applicators, and enables a continuous process of application, drying and removal of steel sections from the application area.

Another benefit is that thick films can be applied in a single coat application, further reducing drying times compared with multiple coats of prior art intumescent coatings.

The present invention utilizes free radical cure and comprises at least one solid thermoplastic polymeric resin component, combined with lower molecular weight liquid monomeric (or oligomeric components) containing ethylenically unsaturated double bonds. Preferably the ethylenically unsaturated double bonds are present as alpha-beta ethylenically unsaturated carboxylate ester groups such as methacrylate or acrylate groups.

The solid thermoplastic polymer is preferably a (meth)acrylic resin, either as a homopolymer, copolymer or terpolymer. The polymeric component ideally comprises a meth (acrylate) copolymer. This may be produced from the polymerization of one or more methacrylate and acrylate monomers, such as any of the following: methyl methacrylate, ethyl methacrylate, n-butyl methacrylate, isobutyl methacrylate, t-butyl methacrylate, 2-hydroxy ethyl methacrylate, 2-hydroxy propyl methacrylate, 2-ethylhexyl methacrylate and the corresponding acrylates. Co-reactants may include styrene and vinyl toluene. The preferred solid thermoplastic polymer is a copolymer of butyl methacrylate and methyl methacrylate.

Other options for the solid thermoplastic polymeric resin component include homopolymers, copolymers or terpolymers derived from vinyl monomers such as any of the following: styrene, vinyl toluene, vinyl chloride, vinyl acetate, vinylidine chloride and vinyl versatate esters. Co-reactants may include dienes such as butadiene.

The solid thermoplastic resin preferably constitutes from 10% to 50% by weight of the resin components of the coating composition.

At least one of the liquid monomeric components preferably contains methacrylate functionality, and most preferably are methacrylic acid esters. Optionally at least one of the monomeric components contains acrylate functionality, and most preferably comprise acrylic acid esters. Additionally the monomeric components should preferably be monofunctional, in order that the resultant polymer produced on reaction with an organic peroxide is thermoplastic and thus melts and flows prior to temperatures at which the intumescent ingredients react.

Examples of suitable methacrylic acid esters and acrylic acid esters include any of the following either alone or in combination: methyl methacrylate, ethyl methacrylate, n-butyl methacrylate, isobutyl methacrylate t-butyl methacrylate, 2-ethylhexyl methacrylate, and the corresponding acrylates. Methyl methacrylate is most preferred methacrylic acid ester due to its ability to produce low viscosity solutions of the solid thermoplastic resin component and its high glass transition temperature. However, its high volatility and characteristic odor, may for certain applications mean that alternative methacrylic acid esters may be preferable. The most preferred acrylic acid ester is 2-ethylhexyl acrylate.

The liquid monomeric components preferably constitute from 30% to 90% by weight of the resin components of the coating composition.

Proprietary resin solutions containing both the aforementioned solid resin and liquid monomers may also contain oligomeric components.

The total resin components ideally constitute from 20% to 60% of the coating composition More preferably the total resin components constitute from 25% to 50% of the coating composition.

The polymeric component and liquid monomers are present in a single pack along with at least one inhibitor component. Without limiting to theory, the presence of a small amount of the inhibitor allows the reactive components (additive and base) to be present together in a single pack. This single can then be mixed with a peroxide present in a second pack and sprayed via single leg spray units due to the increase in pot life from use of the inhibitor.

A general reaction scheme for this process is provided herein.

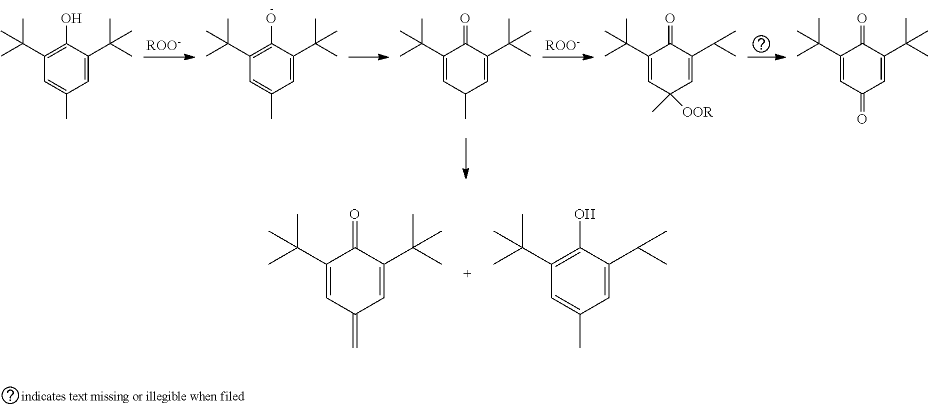

In one or more embodiments, the inhibitor is a phenol or phenol derivative. Suitable examples include, without limitation, butylated hydroxytoluene (BHT), tert-butylcatechol (TBC), hydroquinone (HQ), hydroquinone methyl ether (MEHQ), and 2,4-dimethyl-6-tert-butyl phenol (2,4-DiMe-6-tBu phenol), and the like, as well as mixtures or combinations thereof. In a preferred embodiment, the phenol inhibitor is BHT

In some embodiments, the inhibitor is an aromatic amine or derivative thereof. Suitable examples include, without limitation, benzylamine, aniline, ortho-toluidine, meta-toluidine, para-toluidine, n-methylaniline, N—N′-dimethylaniline, diphenyl and triphenylamine, 1-naphthylamine, 2-naphthylamine, 4-aminophenol, 3-aminophenol, and 2-aminophenol, and the like, as well as mixtures or combinations thereof. In a preferred embodiment, the aromatic amine initiator is aniline.

The amount of inhibitor is determined by the total volume of the ultimate coating composition or paint. In one or more embodiments, the inhibitor is present in an amount of about 0.01 to 0.1% by weight, preferably 0.02 to 0.05% by weight, based on the total weight of the components in the first pack. In a finished coating composition or paint, the inhibitor is present in an amount of about 100 mg to 650 mg per liter of the composition or paint.

One or more initiators present in a second pack are added prior to use to convert the liquid coating to a solid state on the substrate. These are required to initiate the free-radical curing mechanism necessary to convert the monomeric (and oligomeric) components to a solid state. The initiators may be AZO compounds, but are preferably one or more organic peroxides. Suitable classes of organic peroxides include any of the following either alone or in combination: diacyl peroxides, ketone peroxides, peroxyesters, dialkyl peroxides, hydroperoxides and peroxyketals. Diacyl peroxides are preferred, the most preferred peroxide in this class being dibenzoyl peroxide, which may be used in its solid granular form or as a paste with plasticizer. The preferred form of use is as a paste.

The organic peroxide composition content is determined by the total resin content, and preferably constitutes from 0.5% to 5% of the total resin content. More preferably the organic peroxide composition constitutes from 1% to 4% of the total resin content. Note that these figures are based on weight of peroxide proprietary blend as supplied, containing 50% peroxide as active ingredient.

Where dibenzoyl peroxide is used as an initiator, a tertiary amine is preferably added to the coating compositions to accelerate the rate of cure, thus allowing the pot-life and curing time to be optimised. Aromatic tertiary amines are preferred, suitable examples include any of the following: N,N-dimethylaniline and N,N-dialkyl-p-toluidine compounds such as N,N-dimethyl-p-toluidine, N,N-bis-(2-hydroxypropyl)-p-toluidine and N,methyl-n-hydroxyethyl-p-toluidine. The most preferred aromatic tertiary amine accelerators are N,N-dimethyl-p-toluidine, and N,N-bis-(2-hydroxypropyl)-p-toluidine.

The tertiary amine content is determined by the total resin content, and ideally constitutes from 0.1% to 4% of the total resin content. More preferably the tertiary amine constitutes from 0.25% to 3% of the total resin content.

Preferred Azo initiators include any of the following either alone or in combination: 2,2-azobis(-amidinopropane)dihydrochloride, 2,2-azobis(2-methylbutyronitrile), 2,2-azobis(2-methylpropanenitrile), 2,2-azobis(2,4-dimethylpentanenitrile). These are available from Dupont under the trade name of Vazo.

The intumescent coating compositions of the present invention also contain specific ingredients that react together under the influence of heat from a fire, to form a protective insulating foam or char. These ingredients should be of low solubility to ensure that the coating has an acceptable level of durability, and maintains its integrity throughout the service life of the coating. Additionally, the intumescent ingredients used should have a sufficiently small particle size, in order to obtain satisfactory dispersion in the resin components, and thus allow application by spray application methods giving high rates of transfer of the coating to the substrate.

The intumescent ingredients preferably consist of three components, an acid source, a carbon source and a spumific or gas source. Preferably an inorganic “nucleating agent” should be present and optionally additives, which may be solid or liquid in nature, may be added to aid char formation and strengthen the char.

Under the influence of heat (between 100 °C and 200 °C) the resin components melt and begin to flow. As the temperature increases (>200 °C) the acid source, usually by decomposition, produces copious amounts of acid which can react with other constituents in the coating. If the acid source is ammonium polyphosphate, polyphosphoric acids are released which can react with polyhydric alcohols such as pentaerythritol (carbon source) to form polyphosphoric acid esters. The decomposition of these esters leads to the formation of carbon compounds, which together with a blowing agent such as melamine, give rise to a carbon foam or char.

The intumescent coating compositions of the present invention ideally contain at least one acid source, examples of which include ammonium polyphosphate, melamine phosphate, magnesium sulphate and boric acid. The preferred acid source is ammonium polyphosphate.

Ammonium polyphosphate can vary in molecular weight (chain length), the lower the molecular weight, the higher the solubility. By having very high molecular weight and a cross-linked structure it is possible to have very low water solubility, though higher thermal stability is observed. Coating ammonium polyphosphate with silane, melamine or melamine formaldehyde is beneficial in further reducing solubility and can also lead to higher loadings due to a reduction in resin absorbing properties. The use of coated ammonium polyphosphate is preferred, and ammonium polyphosphate coated with melamine formaldehyde is most preferred.

The acid source preferably constitutes from 35% to 65% by weight of the intumescent ingredients content of the coating composition.

The intumescent coating compositions of the present invention ideally contain at least one carbon source, examples of which include polyhydric alcohols such as pentaerythritol, and dipentaerythritol. Starch and expandable graphite are other possible carbon sources. The preferred carbon sources are pentaerythritol and dipentaerythritol or a combination of the two.

The carbon source preferably constitutes from 5% to 40% by weight of the intumescent ingredients content of the coating composition.

The intumescent coating compositions of the present invention ideally contain at least one gas source, examples of which include any of: melamine, melamine phosphate, melamine borate, melamine formaldehyde, melamine cyanurate, tris-(hydroxyethyl) isocyanurate (THEIC), ammonium polyphosphate or chlorinated paraffin. The resin itself may be a gas source as it undergoes decomposition. The preferred gas source is melamine.

The gas source preferably constitutes from 5% to 40% by weight of the intumescent ingredients content of the coating composition.

Although not an essential ingredient in intumescent reactions, inorganic “nucleating” agents are a preferred ingredient since they promote sites for the intumescent char to form, improve the thermal resistance properties and stability of the intumescent char during a fire. The intumescent coating compositions of the present invention ideally contain at least one nucleating agent, examples of which include titanium dioxide, zinc oxide, aluminium oxide, silica, silicates, heavy metal oxides such as cerium oxide, lanthanum oxide and zirconium oxide, mica and bentonite clay. A preferred nucleating agent is titanium dioxide which also provides opacity to the coating.

The nucleating agent preferably constitutes from 1% to 25% by weight of the intumescent ingredients content of the coating composition.

Further optional additives may be optionally included as part of the intumescent ingredients to aid char formation and to strengthen the char and prevent char degradation. Such additives include solids such as zinc borate, zinc stannate, zinc hydroxystannate, glass flake, glass spheres, polymeric spheres, fibres (ceramic, mineral, glass/silica based), aluminium hydroxide, antimony oxide, boron phosphate, fumed silica.

The total intumescent ingredients ideally constitute from 40% to 85% of the total coating composition. More preferably the total intumescent ingredients constitute from 50% to 75% of the total coating composition.

In order that the intumescent coating compositions of the present invention can be applied at high film thickness in a single coat application it is preferred to modify the rheology of the coating by the incorporation of a thixotrope. Suitable thixotropic additives include organically modified inorganic clays such as bentonite clays, hectorite clays or attapulgite clays, organic wax thixotropes based on castor oil and fumed silica. The most preferred thixotropic additives are wax thixotropes and fumed silicas.

The thixotropic additive preferably constitutes from 0% to 2% of the total coating composition. A more preferred level is from 0.05% to 1%.

To improve or facilitate dispersion of the intumescent ingredients and also to reduce the overall viscosity of the intumescent coating, it may be necessary to incorporate wetting/dispersion additives. Such additives are usually liquid in form and can be supplied either containing a solvent or be solvent free. Where required preferably a solvent free wetting agent is used, even more preferably a wetting agent with acid functionality is recommended, at levels between 0% to 2% by weight of the intumescent coating composition.

The components of the intumescent coating compositions, with the exception of the organic peroxide initiator, are preferably blended together by the coating manufacturer using high speed dispersion equipment, whereby the solid intumescent ingredients are wetted out and dispersed in the resin components. Optional dispersion aids may be incorporated to facilitate this process.

The thickness of the coating is ideally at least 250 μm.

Prior to application of the coating the organic peroxide in a second pack is incorporated into the reactive components (polymeric component, liquid ethylenically unsaturated monomer and inhibitor) present in the first pack. This initiates the free radical reactions that will convert the liquid coating to its solid state. Typically, the initiated liquid coating will remain liquid and suitable for application for up to 30 minutes, though this can be modified by varying the quantities of initiator and accelerator in the formulation.

Suitable preferred methods of application of the aforesaid compositions include airless spray, brush, roller, trowel and dipping. Airless spray is most preferred. Airless spray pumps having a ratio of 45:1 or greater, and preferably 60:1 are suitable. A minimum air pressure of greater than 60 psi and preferably 80 psi is required, and the compositions are sprayed using a tip size ranging from 0.015 inch and 0.035 inch.

Conventionally, some multicomponent intumescent coating compositions are applied by means of a plural component spray system. This can be achieved in two ways, as set out below:
1. The initiator (peroxide) component of the coating composition and the main (base) component are pumped separately in the correct ratio through fluid lines to a mixing device. This device mixes the two components automatically and then dispenses the mixed homogenous coating down a further fluid line to the spray tip where the coating is applied as per the abovementioned airless spray application.
2. The second method involves the initial manufacture of two batches of coating. One batch comprises a coating containing no amine accelerators, the other batch comprising a coating containing double the original level of amine accelerators. Prior to application double the original level of initiator (peroxide) is mixed with the batch containing no amine accelerators. The two components are then mixed in the fluid line by plural component spray equipment, but at a more manageable 1:1 mixing ratio (opposed to approximately 50 to 200:1 previously). The in-line mixed liquid coating will have the right level of amine accelerators and initiator (peroxide). In view of the lack of amine accelerators in the batch containing the peroxide, this batch has a much extended use or pot life, typically up to 24 hours thus providing sufficient time to apply all of the mixed material.

In contrast, the coating compositions described herein are intended to be applied by a single-leg spray process. The single-leg spray process is more efficient and cost-effective and the use of a single spray gun and pump means it can be easily and effectively used for on-site application. Instead of the multiple feed lines and mixers necessary for plural component spray application, the single-leg process allows the first pack to be mixed with the second pack right before application and sprayed with a single gun.

The coating compositions should be stored under cool conditions, and ideally application should only be carried out under such conditions. Where it is necessary to apply the coating compositions at higher temperatures, then modified formulations that have been adjusted for initiator or accelerator should be used.

The coating compositions of the present invention can be applied in liquid form to steel sections up to several meters in length with a gauge thickness typically ranging from 5 mm to 30 mm or greater. Depending on the Hp/A of the steel section coating can be applied at the required thickness to achieve up to 120 minutes fire protection.

Steel sections requiring fire protection are normally blast cleaned prior to the application of an intumescent coating to remove millscale and other deposits that may lead to premature failure of the intumescent coating, either on prolonged atmospheric exposure or during a fire situation. In order to prevent deterioration of the blast cleaned surface, particularly where there is a delay in applying the intumescent coating, it is normal practice to apply a primer coating. This is often the case when the intumescent coating is applied on site.

Examples of suitable primers are coatings based on epoxy, modified epoxy (such as modified with polyvinyl butyral), polyurethane, acrylic, vinyl and chlorinated rubber. Primers based on epoxy are preferred.

The thickness of the primer is ideally in the range from 15 microns to 250 microns. Preferably the thickness should be in the range from 25 microns to 100 microns.

A topcoat may be applied to the cured intumescent coatings of the present invention, particularly to provide color to exposed steelwork. A topcoat if correctly formulated will also enhance the durability of the intumescent coating compositions. A clear sealer may also be suitable.

Examples of suitable topcoats are coatings based on epoxy, polyurethane, alkyd, acrylic, vinyl and chlorinated rubber. Topcoats based on polyurethane and acrylic are preferred.

The thickness of the topcoat can vary from 15 microns to 250 microns. Preferably the thickness should be in the range from 25 microns to 75 microns, as too high a thickness of topcoat may inhibit the intumescent reactions.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts, ratios, and percentages are by weight and all molecular weights are number average molecular weight (Mn). An exemplary coating composition as described herein may include additional materials in varying concentrations. For example, the composition may further include one or more fillers, wet and dry flow agents, adhesion promoters, and combinations thereof. Unless otherwise specified, all chemicals used are commercially available.

### Example 1. Preparation of Coating Composition

An exemplary formulation of the liquid intumescent coating composition described herein was made by combining ingredients as shown in Table 1 below to form the first part of the composition. A control formulation based on a commercially available intumescent composition that does not include the inhibitor component is also prepared. The first part of the composition is mixed with the second part of the composition, i.e. a peroxide initiator, just before the coating composition is applied.

A comparison of the pot life of the control formulation and exemplary formulation can be seen in FIG. 1. The addition of the inhibitor to the first part significantly improves the pot life of the exemplary formulation such that it can be efficiently applied by a single leg process.

TABLE 1
Components in Latex Preparation

| | Weight |
|---|---|
| Component | % |
| Acrylic resin (solid | 10-20% |
| thermoplastic) | |
| Acrylic resin (derived from | |
| ethylenically unsaturated | 10-20% |
| monomeric component) | |
| Wetting and dispersing additive | <0.2% |
| Rheology modifier | <0.1% |
| Dispersing additive | <0.1% |
| Wetting additive | <0.1% |
| Titanium dioxide | 8-14% |
| Phenol derivative (inhibitor) | <0.05% |
| Carbon black | <0.1% |
| Pentaerythritol | 8-14% |
| Zinc Borate | <2% |
| Melamine | 8-14% |
| Ammonium polyphosphate | 25-35% |
| Bentone | 0.1% |
| Chlorinated Paraffin | 2-6% |
| Mineral Fibres | 1% |

The complete disclosure of all patents, patent applications, and publications, and electronically available material cited herein are incorporated by reference. The foregoing detailed The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A liquid intumescent coating composition comprising:
at least one polymeric component, said at least one polymeric component comprises solid thermoplastic resin, at least one ethylenically unsaturated monomeric component, and at least one intumescent ingredient component comprising an acid source in combination with another intumescent ingredient;
an inhibitor component;
and an initiator component for initiating a reaction to cure the coating composition to a solid state by free radical polymerization.

2. A liquid intumescent coating composition as claimed in claim 1, wherein the solid thermoplastic resin comprises at least one homopolymer, copolymer and/or terpolymer of methacrylic resin.

3. A liquid intumescent coating composition as claimed in claim 1, wherein the solid thermoplastic resin comprises a meth (acrylate) copolymer.

4. A liquid intumescent coating composition as claimed in claim 1, wherein the solid thermoplastic resin comprises the reaction product of at least one of styrene or vinyl toluene together with at least one of any of the following: methyl methacrylate, ethyl methacrylate, n-butyl methacrylate, isobutyl methacrylate, t-butyl methacrylate, 2-hydroxy ethyl methacrylate, 2-hydroxy propyl methacrylate, 2-ethylhexyl acrylate, methyl acrylate, ethyl acrylate, n-butyl acrylate, isobutyl acrylate, t-butyl acrylate, 2-hydroxy ethyl acrylate, 2-hydroxy propyl acrylate, and 2-ethylhexyl acrylate.

5. A liquid intumescent coating composition as claimed in claim 1, wherein the solid thermoplastic resin comprises the reaction product of one or more diene together with at least one any of the following: styrene, vinyl toluene, vinyl chloride, vinyl acetate, vinylidine chloride, and vinyl versatate esters.

6. A liquid intumescent coating composition as claimed in claim 1, wherein the ethylenically unsaturated monomeric component comprises any of the following either alone or in combination: methyl methacrylate, ethyl methacrylate, n-butyl methacrylate, isobutyl methacrylate, t-butyl methacrylate, 2-ethylhexyl acrylate, methyl acrylate, ethyl acrylate, n-butyl acrylate, isobutyl acrylate, t-butyl acrylate, and 2-ethylhexyl acrylate.

7. A liquid intumescent coating composition as claimed in claim 1, wherein said polymeric component and said ethylenically unsaturated monomeric component together constitutes from 20% to 60% of the coating composition.

8. A liquid intumescent coating composition as claimed in claim 1, wherein said at least one polymeric component constitutes from 10% to 50% by weight of the combined polymeric component and ethylenically unsaturated monomeric component.

9. A liquid intumescent coating composition as claimed in claim 1, wherein said at least one ethylenically unsaturated monomeric component constitutes from 30% to 90% by weight of the combined polymeric component and ethylenically unsaturated monomer.

10. A liquid intumescent coating composition as claimed in claim 1, wherein said another intumescent ingredient comprises a carbon source and a gas source.

11. A liquid intumescent coating composition as claimed in claim 1, wherein said acid source is selected from the group consisting of: ammonium polyphosphate, melamine phosphate, magnesium sulphate, and boric acid, and wherein said acid source is coated to further reduce solubility with a coating selected from the group consisting of silane, melamine, or melamine formaldehyde.

12. A liquid intumescent coating composition as claimed in claim 1, wherein said acid source constitutes from 35% to 65% by weight of the at least one intumescent ingredient component.

13. (canceled)

14. (canceled)

15. A liquid intumescent coating composition as claimed in claim 1, wherein said inhibitor component is selected from a phenol, an aromatic amine, derivatives of phenol, derivatives of aromatic amines, or mixtures thereof.

16. A liquid intumescent coating composition as claimed in claim 1, wherein said inhibitor component is a phenol or derivative thereof.

17. (canceled)

18. (canceled)

19. (canceled)

20. A method of curing a liquid intumescent coating composition to a solid state by free radical polymerization comprising the step of adding an organic peroxide initiator to the liquid intumescent coating composition, wherein the coating composition comprises
at least one polymeric component, said at least one polymeric component comprises solid thermoplastic resin, at least one ethylenically unsaturated monomeric component and at least one intumescent ingredient component comprising an acid source in combination with another intumescent ingredient; and
an inhibitor component,
wherein the inhibitor component is included in a single pack with the polymeric component.

21. A method as claimed in claim 20, wherein the organic peroxide comprises any of the following either alone or in combination: diacyl peroxides, ketone peroxides, peroxyesters, dialkyl peroxides, hydroperoxides and peroxyketals.

22. A method as claimed in claim 20, wherein the coating composition is cured in about 90 minutes at a temperature of 20 °C+/−3 °C.

23. A method as claimed in claim 20, wherein less than 5% by weight of volatile components is lost by evaporation during the conversion of the composition to a solid state by the addition of an organic peroxide.

24. (canceled)

25. (canceled)

26. (canceled)

27. (canceled)

28. A two-pack composition comprising the liquid intumescent coating composition of claim 1, wherein the two-pack composition comprises:
a first pack comprising
a solid thermoplastic resin; and
at least one ethylenically unsaturated monomeric component; and
at least one intumescent ingredient comprising an acid source in combination with another intumescent ingredient; and
an inhibitor; and
a second pack comprising
a peroxide initiator for initiating a reaction to cure the coating composition to a solid state by free radical polymerization; and
a tertiary amine catalyst.

29. (canceled)

30. A method of applying the two-pack composition of claim 28, the method comprising:
providing a first pack comprising at least one polymeric component, said at least one polymer component comprising
a solid thermoplastic resin;
at least one ethylenically unsaturated monomeric component; and
an inhibitor component; and
at least one intumescent ingredient component comprising an acid source in combination with another intumescent ingredient; and
providing a second pack comprising a peroxide initiator;
mixing the first part and the second part to form a mixture to initiate a reaction to cure the coating composition to a solid state by free radical polymerization;
applying the mixture to a substrate by a single-leg spray process.
